(19) United States
(12) Patent Application Publication
(10) Pub. No.: US 2014/0079237 A1
(43) Pub. Date: Mar. 20, 2014

(54) RETRACTABLE EAR BUD ASSEMBLY HAVING A WIRELESS RECEIVER

(71) Applicants: John Cataldo, Westlake Village, CA (US); Daniel C. Sullivan, Santa Barbara, CA (US); Mardis Bagley, San Francisco, CA (US)

(72) Inventors: John Cataldo, Westlake Village, CA (US); Daniel C. Sullivan, Santa Barbara, CA (US); Mardis Bagley, San Francisco, CA (US)

(73) Assignee: HEADLOGIC LLC, Westlake Village, CA (US)

(21) Appl. No.: 13/621,332

(22) Filed: Sep. 17, 2012

(51) Int. Cl. H04R 1/10

(52) U.S. Cl. CPC H04R 1/1033
USPC 381/74; 381/384

(57) ABSTRACT

A retractable ear bud module. The ear bud module is has a housing for holding an ear bud cable, an ear bud cable moveably mounted in the housing, the ear bud cable having a free end with at least one ear bud and a fixed end. A circuit board including a wireless receiver mounts in the housing for communicating with the electronic device. The wireless receiver electronically connects with the ear bud cable to transfer audio signals from the electronic device to the ear bud. A retraction mechanism mounts in the housing to retract and dispense the ear bud cable. The retraction mechanism includes a rotatable spool mounted in the housing, a spring recessed centrally within the spool, and an annular retainer circumscribing the spool to align the ear bud cable on the spool.

### RELATED APPLICATIONS

This patent application relates in subject matter to commonly assigned U.S. patent application Ser. Nos. 13/405,132, 13/366,605 and 12/206,246, the disclosures of which are incorporated herein by reference.

### FIELD OF THE INVENTION

The present invention relates to ear bud management mechanisms that dispense and retract ear bud cables, and cases that are connectable with ear bud management mechanisms.

### BACKGROUND OF THE INVENTION

Ear buds are devices that attach to the ear or head of a user to deliver sound directly to the ear in a personal way. Ear buds may attach to the pinna, lobule, or insert within the external auditory canal. Ear buds may also hang from the head and cover a portion of the ear. The sound delivered typically can be heard by the user, but others have difficulty hearing at the typical sound volume delivered.

One benefit of using ear buds is that an electronic device may be distanced from a user's ear to minimize electro-magnetic fields, which are known to impair the electrical fields in the brain, sometimes causing headaches or heat buildup in the head. Another benefit is to minimize interference with ambient sounds. Yet another benefit is to minimize eavesdropping. Since an ear bud need not be held by a user, this frees the hands for other activities.

Ear buds are commonly used with telephones, music players, computers and other portable, and non-portable, electronic devices.

One major drawback of using wired ear buds with electronic devices is cord management. Cord management is a commonly experienced problem where the cord of the ear buds becomes tangled. Ear bud cords may be damaged by a frustrated user who attempts to hastily untangle the cord. Operating an automobile or other vehicle while experiencing cord management problems can be dangerous. What is desired is a better way of cord management which enables the user to readily extend and retract ear bud cables in an easy and reliable manner.

CN101959097 assigned to Nantong Xining Design Service Co., Ltd., discloses an audio receiver for an earphone device that attaches to clothing. The receiver receives wireless signals and includes an earphone socket. The wireless signals are communicated via the earphone socket to earphone. This enables a remotely located electronic device to broadcast to the receiver, and the user to employ earphones to hear the broadcast. The earphone cables are stored in the receiver. Unfortunately, the cord management problem is not fully resolved.

U.S. Pat. No. 8,047,365 to Lin et al. discloses a folding case that has one side for holding an electronic device and another side that magnetically secures ear buds. The folding case includes electrical connections between the ear buds and the electronic device. The magnetic connection helps with ear bud management, and inhibits damage to the cord.

While the state of the art shows a trend toward convenience of use of ear buds with electronic devices and cases for electronic devices, there is also a lack of effective ways for managing ear bud cables. What is desired is a way of managing ear bud cables that is convenient, safe and durable.

### SUMMARY OF THE INVENTION

A retractable ear bud module has a housing that removeably connects to a case for an electronic device. The housing holds an ear bud cable that is moveably mounted in the housing. The ear bud cable has a free end and a fixed end. At least one ear bud mounts on the free end. A circuit board having a wireless receiver mounts in the housing for receiving audio signals from the electronic device. The ear bud cable has a fixed end hard-wired to the wireless receiver to establish electronic communication between the wireless receiver and the ear bud. The ear bud cable cooperates with the wireless receiver to communicate audio signals between the electronic device and the ear buds.

The housing includes a retraction mechanism mounted in the housing for selectively retracting and dispensing the ear bud cable, the retraction mechanism includes a spool rotatably mounted in the housing, a spring mounted centrally and recessed within the spool to selectively rotate the spool, and an annular retainer circumscribing the spool to align the spool within the housing and to align the ear bud cable on the spool.

In one embodiment of the invention, the spool has a top level and a bottom level, the top level stores a first portion of the ear bud cable, and the bottom level stores a second portion of the ear bud cable. The ear bud cable has a fixed end hard-wired to the wireless receiver to establish a hard-wired electrical connection between the ear bud cable and the wireless receiver.

The housing includes a pawl latch and switch assembly having a pawl latch and a switch. The pawl latch normally engages the spool and rotatably mounts in the housing. Actuation of the switch causes the pawl latch to release the spool to enable the spring to spin the spool to retract the ear bud cable. Preferably, the pawl latch and switch assembly is formed as a unitary structure.

The housing includes a rechargeable battery and a charging port. The rechargeable battery mounts in the housing and in electrical connection with the wireless receiver to power the wireless receiver. The charging port electrically connects with the battery and mounts on the housing.

The housing includes a hinged cover mounted on the housing for covering the ear buds when the ear buds are retracted and a volume control switch mounted on the housing for regulating audio output of the ear buds. The hinged cover inhibits entry of contaminants into the housing and keeps the ear buds clean.

### BRIEF DESCRIPTION OF THE DRAWINGS

The present invention is described in terms of various examples as set forth in the drawings, in which:

FIG. 1 is a perspective view of a retractable ear bud mechanism attached to a case for an electronic device in accordance with the present invention.

FIG. 2 is a perspective view of the retractable ear bud mechanism having a hinged cover in a closed configuration.

FIG. 3 a perspective view of the retractable ear bud mechanism of FIG. 2 having the hinged cover in an open configuration.

FIG. 4 is a perspective view of an embodiment of the retractable ear bud mechanism with a port removed to display the spool of the present invention.

FIG. 5 is a cutaway perspective view of the retractable ear bud mechanism as seen along the line 5-5 of FIG. 2.

FIG. 6 is an exploded perspective view of the retractable ear bud mechanism of FIG. 4.

### DETAILED DESCRIPTION

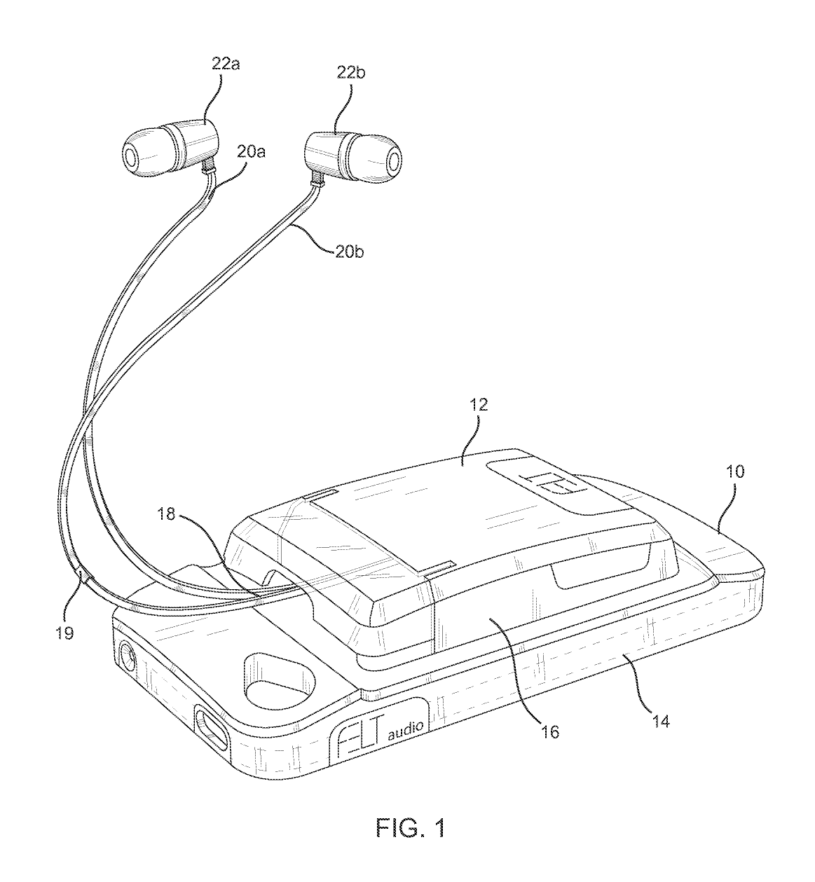

FIG. 1 shows a case 10 in accordance with the present invention and a ear bud module 12. The ear bud module 12 removeably attaches to the case 10. The case 10 holds electronic device 14 having an audio output capability. The electronic device 14 is preferably a telephone, the music player smart phone, a tablet computer, or other computing device having audio output capability.

In a preferred embodiment, the electronic device 14 is enabled with wireless audio output capability, for example a Bluetooth™™ communication module having a radio and a processor, where the radio transmits and receives audio signals via a host-less Bluetooth™ communication protocol such as defined by the trade organization, Bluetooth SIG, and other trade organizations.

The ear bud module 12 removeably attaches to the case 10. This removable attachment can include a clipped attachment that includes a press-fit between the ear bud module 12 and the case 10. In an alternate embodiment of the invention the ear bud module 12 slidably connects to the case 10. The use of a user actuated switch supplements the press-fit and slideable connection between the ear bud module 12 and the case 10 to enable a locking connection between the case 10 and the ear bud module 12.

The ear bud module 12 includes a housing 16 and an ear bud cable 18, which retractably holds an ear bud cable 18. The ear bud cable 18 has free ends 20a and 20b and ear buds 22a and 22b attached to the free ends 20a and 20b, respectively.

In one embodiment, the ear bud cable 18 is equipped with a microphone 19 to enable telephonic communication between the microphone 19 and an electronic device.

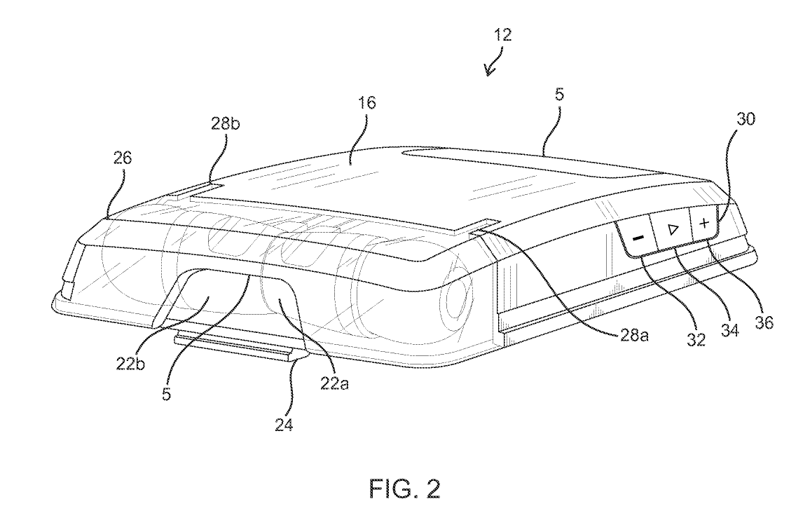

FIG. 2 shows the ear bud module generally designated with the reference numeral 12. The ear bud module 12 includes at least one clip 24 for removeably attaching the ear bud module 12 to a case. Preferably, the ear bud module 12 has more than one clip 24. The ear buds 22a and 22b are shown in a retracted configuration.

The ear bud module 12 has a cover 26 mounted on the housing 16 for covering the ear buds 22a and 22b when the ear buds 22a and 22b are retracted. The cover 26 is shown closed on the housing 16. The cover 26 has two hinges 28a and 28b that assure alignment of the cover 26 on the housing 16 when the cover 26 is closed, and to enable the cover 26 to open. Preferably the cover 26 is made from transparent material to reveal the ear buds 22a and 22b when the cover 26 is closed.

The housing 16 includes a control switch 30, which includes a down volume actuator 32, and up volume actuator 36 and a skip actuator 34. The volume actuators regulate the volume of sound communicated to the ear buds 22a and 22b. The skip actuator 34 enables a user to selectively bypass an audio file when a series of audio files are streamed to the ear bud module 12 from an electronic device.

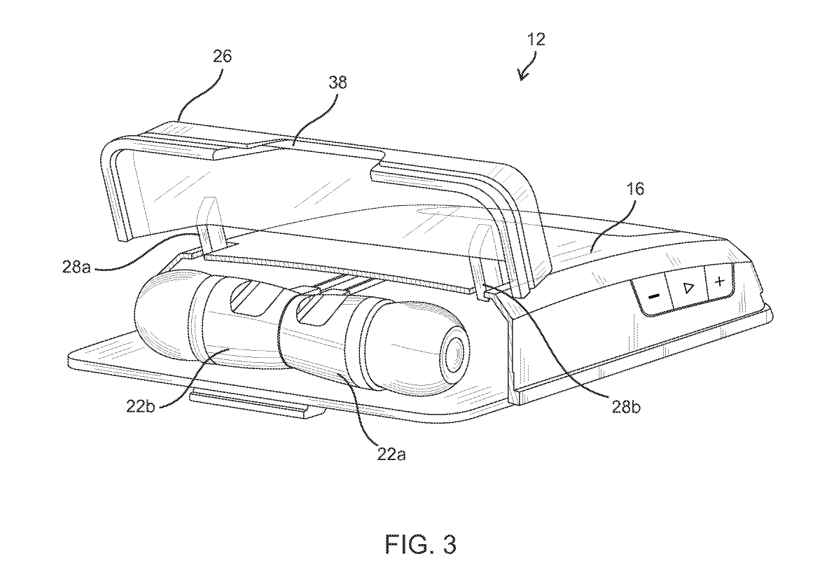

FIG. 3 shows the ear bud module 12 with the cover 26 open. The cover 26 has a handle 38 to enable a user to open and close the cover 26. As shown the handle 38 includes a recess defining an opening in the cover 26 sized to enable the finger of a user to insert into the cover 26 to grip and open the cover 26. The hinges 28a and 28b restrict the cover 26 when it opens and limit the cover opening to approximately a 90 degree angle with respect to the housing 16. Restricting the angle of the cover 26 when it opens enables the hinges 28a and 28b to be shaped so the hinges 28a and 28b only minimally protrude into the housing 16 during movement. Thus the hinges 28a and 28b are designed to minimize potential interference between the cover 38 and the ear buds 22a and 22b.

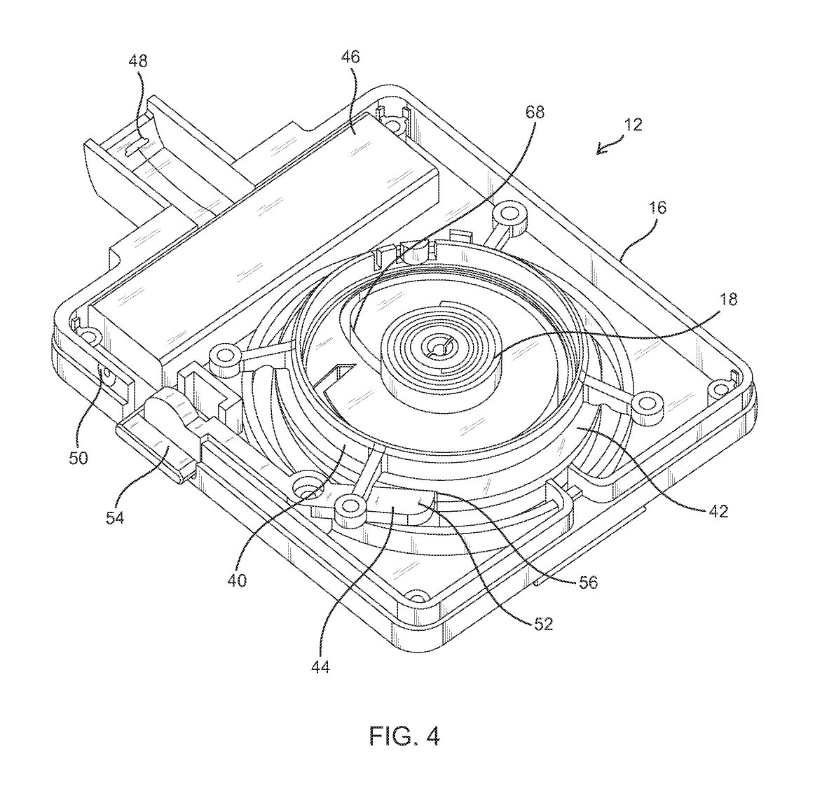

FIG. 4 shows the ear bud module 12 with a portion of the housing 16 removed. The ear bud module 12 includes a retraction mechanism 40 having including a rotatable spool 42, a pawl latch and switch assembly 44, a rechargeable battery 46, a charging port 48 and a power switch 50.

The retraction mechanism 40 and the spool 42 enable the ear bud cable 18 to wrap around the spool 42 for stowing and dispensing the ear bud cable 18. The ear bud cable 18 is a flat cable to minimize tangles and to maximize stowage capacity of the spool 42.

The pawl latch and switch assembly 44 normally engages the spool to enable the spool to extend a desired length of ear bud cable 18. The pawl latch and switch assembly 44 includes a pawl latch 52 and a switch 54. The switch 54 selectively disengages the pawl latch 52 from the spool 42. The spool 42 includes a notch 52 that normally engages with the pawl latch 52 and cooperates with the pawl latch 52 to inhibit retraction of the ear bud cable 18. Actuation of the switch 54 releases the pawl latch 52 from the spool notch 52 to enable the spool to retract and stow the ear bud cable 18.

The pawl latch 52 and the switch 54 are a unitary structure to form the pawl latch and switch assembly 44, which pivotally mounts in the housing 16.

The charging port 48 enables recharging of the battery 46. The battery 46 powers a wireless communication module integrated in the housing 16, which wirelessly communicates with an electronic device. The power switch 50 selectively enables operation of the wireless communication module.

The spool 42 defines a slot 68 that enables the ear bud cable 18 to extend through the spool 42. The slot 68 has a spiral shape to enable the ear bud cable 18 to extend through the spool from a top level to a bottom level of the spool. The spiral shape enables the ear bud cable 18 to form slack that readily slides through the slot 68 when the ear bud cable is dispensed and retracted.

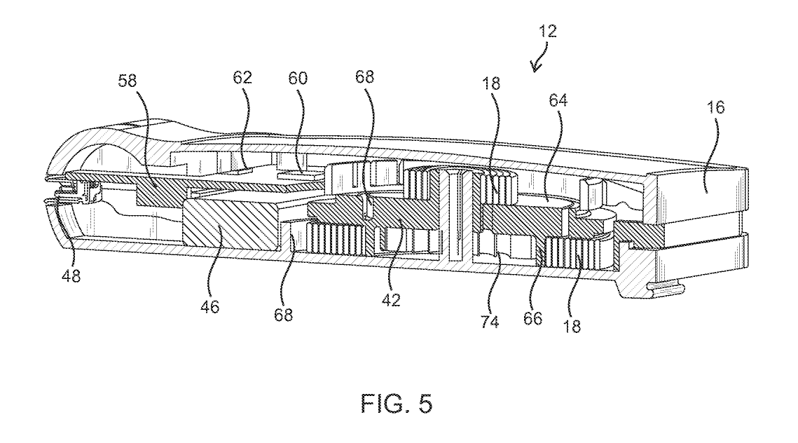

FIG. 5 shows a cutaway view of the ear bud module 12 as seen along the line 5-5 of FIG. 2. The ear bud module 12 includes the charging port 48 electrically connected with the battery 46 via a circuit board 58. The circuit board includes a processor 60 and a wireless receiver 62. The wireless receiver 62 includes a circuit board having various circuitries including a Bluetooth™ radio for transmitting and receiving signals from an electronic device equipped with Bluetooth™ capability. It can be appreciated that the wireless receiver 62 can be readily adapted to communicate via various other protocols to enable wireless communication between an electronic device and the ear bud module 12. These protocols can include UHF near field communication protocols, infrared communications protocols and other protocols capable of enabling two-way communication between an electronic device and an ear bud module. Instructions, in addition to audio signals, are communicated between the electronic device 14 (FIG. 1) and the ear bud module 12.

The ear bud cable 18 has a middle portion that wraps around a top level 64 of the spool 42 and the middle portion also wraps around the bottom level 66 of the spool 42. The spool 42 is configured with at slot 68 situated between the top level 64 and the bottom level 66 to enable the ear bud cable 18 to feed between the top level 64 and the bottom level 66 of the spool 42. As the spool 42 unwinds ear bud cable 18 slackens in the top portion 64, releasing additional length of ear bud cable 18 to the bottom level 66.

The retraction mechanism 40 includes the spool 42 and a retainer 70. The retainer 70 circumscribes the middle portion of the ear bud cable 18 that wraps around the spool 42. The retainer 70 mounts in the housing 16 with screws to retain the spool 42 in the housing and maintain alignment of the spool 42 in the housing 16.

The ear bud cable 18 has a fixed end 68 that is hard wired to the circuit board 58 to assure integrity of the audio signals communicated from the wireless receiver 62 of the circuit board 58 to the ear buds 22a and 22b (FIG. 1). Preferably the hard wired connection between the circuit board 58 and the fixed end 68 is a solder joint. Although a hard wired connection between the fixed end 68 of the ear bud cable 18 and the circuit board 58 is described, alternate connections are possible; including a plug or other mechanism for interconnecting an ear bud cable 18 to a circuit board 58 that assures signal integrity can be used.

The spool 42 includes a recessed portion on the bottom level 66 of the spool 42 which holds a spring 74. The spring 74 is recessed in the spool 42 to minimize height of the housing 16. A portion of the ear bud cable 18 wraps around the bottom portion 66 of the spool 42 and circumscribes the spring 74. The arrangement of the ear bud cable 18 circumscribing the spring 74 on the bottom level 66 of the spool 42 minimizes height of the ear bud module.

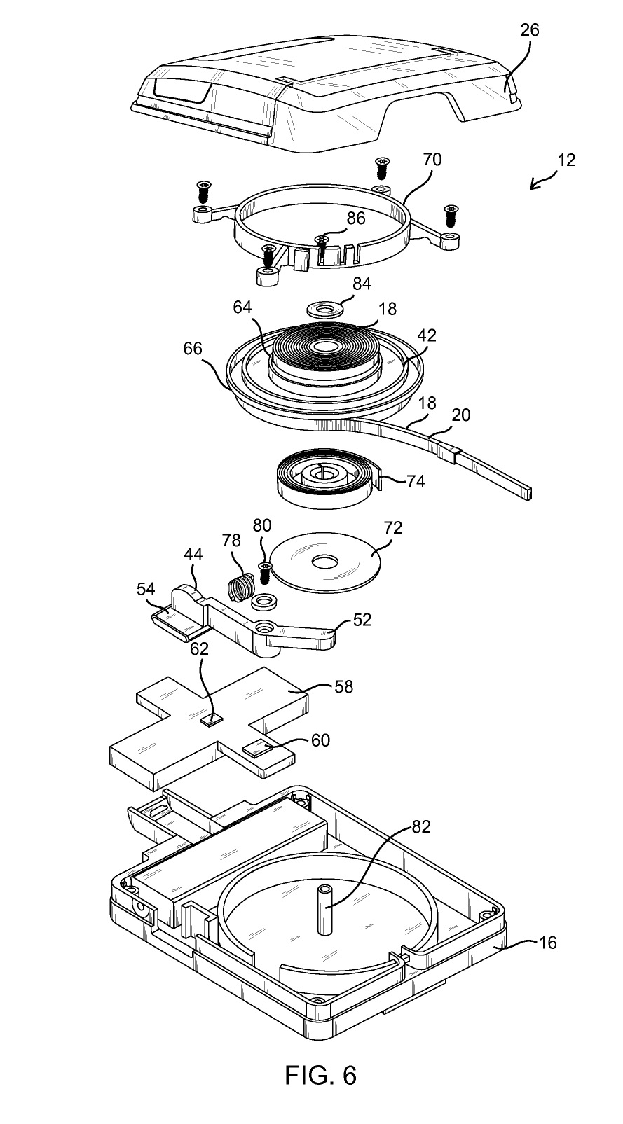

FIG. 6 is an exploded view of the ear bud module 12 of FIG. 4, including the housing 14, the circuit board 58 with the wireless receiver 62, the pawl latch and switch assembly 44, a spring retainer 72, the spring 74, the ear bud cable 18, the spool 42, and the cover 26.

The spring retainer 72 is an annular plate that enables the spring 74 to slide freely when it coils and uncoils to rotate the spool 42.

The pawl latch and switch assembly 44 includes an actuator spring 78 and screw 80 that cooperate to bias the pawl latch and switch assembly 44 in a locking orientation to inhibit retraction of the ear bud cable 18 and counter-rotation of the spool 42. Counter-rotation of the spool 42 retracts the ear bud cable 18. Actuation of the switch 54 releases the paw latch 52 from the spool to enable the spring 74 to counter-rotate the spool 42 and thus enable retraction of the ear bud cable 18.

The housing 16 includes an axel 82 that is formed in the housing 16 to receive the spool 42. A screw 86 and retainer 84 cooperate to screw the spool 42 on the axle 82 to hold the spool 42 in a fixed axial orientation, while enabling the spool 42 to rotate about the axel 82.

While the present invention is disclosed in terms of various embodiments, including preferred embodiments, it can be appreciated that the true scope of the invention is defined only by the appended claims.

1. A retractable ear bud module, comprising:
a housing for holding an ear bud cable;
an ear bud cable moveably mounted in the housing, the ear bud cable having a free end;
at least one ear bud mounted on the free end of the ear bud cable;
a wireless receiver mounted in the housing for receiving audio signals, the wireless receiver being in electronic communication with the ear bud cable to communicate audio signals to the ear bud; and
a retraction mechanism mounted in the housing for selectively retracting and dispensing the ear bud cable.

2. The ear bud module as set forth in claim 1, wherein the retraction mechanism includes a rotatable spool;
the ear bud cable has a fixed end hard-wired to the wireless receiver to establish a hard-wired electrical connection between the ear bud cable and the wireless receiver, and
the ear bud cable has a middle portion wrapped around the spool to enable the ear bud cable to be selectively retracted and dispensed when the spool rotates.

3. The ear bud module as set forth in claim 2, wherein the spool has a top and a bottom level and defines a slot that enables the ear bud cable to extend between the top level and the bottom level.

4. The ear bud module as set forth in claim 3 further comprising:
a rechargeable battery mounted in the housing and in electrical connection with the wireless receiver to power the wireless receiver, and
a charging port electrically connected with the battery and mounted on the housing.

5. The ear bud module as set forth in claim 3 further comprising:
a volume control switch mounted on the housing for regulating audio output of the ear buds.

6. The ear bud module as set forth in claim 3, wherein the housing has clips for removeably attaching the housing to a case for an electronic device.

7. A case having a removable ear bud module, comprising:
a case for holding an electronic device having audio-output capability;
a housing for holding an ear bud cable, the housing being attachable to the case;
an ear bud cable moveably mounted in the housing, the ear bud cable having a free end;
at least one ear bud mounted on the free end of the ear bud cable;
a wireless receiver mounted in the housing for receiving audio signals from the electronic device, the wireless receiver being in electronic communication with the ear bud cable to communicate audio signals to the ear bud; and
a retraction mechanism mounted in the housing for selectively retracting and dispensing the ear bud cable.

8. The case as set forth in claim 7, wherein the housing has clips for removeably attaching the housing to the case, the case is configured for holding the electronic device, the electronic device being chosen from the group consisting of: a cellular telephone, a audio player, and a notepad computing device.

9. The case as set forth in claim 7 further comprising:
a rechargeable battery mounted in the housing and in electrical connection with the wireless receiver to power the wireless receiver, and
a charging port electrically connected with the battery and mounted on the housing.

10. The case as set forth in claim 7 further comprising:
a hinged cover mounted on the housing for covering the ear bud when the ear bud is retracted.

11. The case as set forth in claim 7 further comprising:
a volume control switch mounted on the housing for regulating audio output of the ear buds, the volume control switch includes a skip switch to enable a user to communicate a skip signal to the electronic device to skip playback of an audio file communicated to the wireless receiver from the electronic device.

12. The case as set forth in claim 7, wherein the retraction mechanism includes a rotatable spool, and the ear bud cable has a fixed end, the fixed end being hard-wired to the wireless receiver to establish a hard-wired electrical connection between the ear bud cable and the wireless receiver.

13. A retractable ear bud module, comprising:
a housing for holding an ear bud cable;
an ear bud cable moveably mounted in the housing, the ear bud cable having a free end;
at least one ear bud mounted on the free end of the ear bud cable;
a wireless receiver mounted in the housing for receiving audio signals, the wireless receiver being in electronic communication with the ear bud cable to communicate audio signals to the ear bud; and
a retraction mechanism mounted in the housing for selectively retracting and dispensing the ear bud cable, the retraction mechanism includes a spool rotatably mounted in the housing, a spring mounted centrally within the spool, and an annular retainer circumscribing the spool to align the ear bud cable on the spool.

14. The ear bud module as set forth in claim 13, wherein the spool has a top level, a bottom level, and a slot defined between the top level and the bottom level, the top level stores a first portion of the ear bud cable, and the bottom level stores a second portion of the ear bud cable and the slot enables the ear bud cable to feed between the top level and the bottom level.

15. The ear bud module as set forth in claim 13 further comprising:
a rechargeable battery mounted in the housing and in electrical connection with the wireless receiver to power the wireless receiver, and
a charging port electrically connected with the battery and mounted on the housing.

16. The ear bud module as set forth in claim 13 further comprising:
a hinged cover mounted on the housing for covering the ear bud when the ear bud are retracted.

17. The ear bud module as set forth in claim 13 further comprising:
a volume control switch mounted on the housing for regulating audio output of the ear buds.

18. The ear bud module as set forth in claim 13, wherein the retraction mechanism includes a rotatable spool, and the ear bud cable has a fixed end hard-wired to the wireless receiver to establish a hard-wired electrical connection between the ear bud cable and the and the wireless receiver.

19. The ear bud module as set forth in claim 18, wherein the housing includes a pawl latch and switch assembly, the pawl latch normally engages the spool, and actuation of the switch causes the pawl latch to release the spool to enable the spring to spin the spool to retract the ear bud cable.

20. The ear bud module as set forth in claim 19, wherein the pawl latch and switch assembly rotatably mounts in the housing and is formed as a unitary structure.
